(19) United States
(12) Patent Application Publication
(10) Pub. No.: US 2005/0011970 A1
(43) Pub. Date: Jan. 20, 2005

(54) Underground sprinkler with pop-up head object of the invention

(75) Inventor: Pablo Rodriguez Fernandez, Burgos (ES)

Correspondence Address: DENNISON, SCHULTZ, DOUGHERTY & MACDONALD, 1727 KING STREET, SUITE 105, ALEXANDRIA, VA, 22314, US

(73) Assignee: VYR-VALVULERIA Y RIEGOS POR ASPERSION, S.A.

(21) Appl. No.: 10/716,511

(22) Filed: Nov. 20, 2003

(30) Foreign Application Priority Data
Jul. 18, 2003 (ES) 200301704

(51) Int. Cl. B05B 15/10

(52) U.S. Cl. 239/205; 239/204; 239/203; 239/575

(57) ABSTRACT

An underground sprinkler with a pop-up head and a corresponding underground casing has two differentiated cylindrical parts, closed by a corresponding cover fixed to the pop-up sprinkler head, which, being a part coupled to the piston, pops-up due to the effect of the water pressure pushing the piston in a portion calculated for this purpose and which is so maintained for as long as the pressure lasts, to be recovered by the action of a permanent draw-spring when the pressure stops.

### OBJECT OF THE INVENTION

Coinciding with the title, the object of the invention is a sprinkler, of those which are buried underground and are provided with a pop-up head with the sprinkler means, the spray arc adjustment and control mechanism and the return and swing device for carrying the sprinkler jet to both sides of the position of the head, covering the arc previously established with the adjustment and control mechanism, an arc adjusted so as to water a useful surface, thereby preventing watering of a useless surface.

The object at hand is therefore a sprinkler of those comprised of an underground casing of downwardly decreasing diameters and the interior of which houses the remaining mechanisms; a piston controlled by a coaxial spring ascending due to water pressure; having a filter for preventing the passing of impurities, debris or materials and which, in its ascent, pushes the pop-up head of the sprinkler with all its mechanisms, lifting the cover closing said casing when it is underground.

The pop-up head is therefore provided with a control mechanism incorporated in the neck of the piston of a damping member and a catch device for fixing in place the position of the sprayer, the spray blade and the counterweight arm when the spray arc is not controlled, where different mechanisms intervene for opening or closing the catch, according to whether spraying with a controlled arc or fixed spray is desired or not.

Therefore, the object of the invention is a sprinkler of this type which has been advantageously improved, on one hand, in the water inlet filtering body; in the fixing means for fixing the sprinkler to the underground casing; in the debris disposal conditions and in the manner and means of fixing the spray arc. On the other hand, new fixing means for fixing the two parts of the sprinkler; a jet breaker element, a special shaft for preventing the pop-up head from being released during its spraying duties, and finally, the contribution of a blade without counterweights; a special assembly and reinforcement means along said blade.

### BACKGROUND OF THE INVENTION

The background of the invention mainly refer to those existing sprinklers of the American trademark “Rain Bird”, of Anthony Manufacturing Corp., which is the owner of currently lapsed patent number U.S. Pat. No. 4,182,494, filed in 1978, corresponding to: “ANTI SIDE SPLASH DRIVE ARM FOR AN IMPACT DRIVE SPRINKLER”, constituting the basis for underground sprinklers with a pop-up spray head.

Based on these sprinklers, currently the “MAXI-PAW” models are found, among which the “AG-5” prototype shows a traditional watertight or closed body with downwardly decreasing diameters, and a filtering element joined to the piston shifting with it when it moves up or down.

The piston in question is prismatic and retained by means of a nozzle which screws into the inner wall of the casing and which has a head in the shape of a hexagonal nut, assembled by means of a socket wrench, and several spray head arc controllers, which are composed of corresponding omega-shaped metal strips which pressure fit in said grooves, are assembled in respective circular grooves on the outside of the top end of the piston.

The sprinkler shaft is fixed to the sprinkler head by a corresponding threaded fitting. It is a head which in this case comprises a diffuser blade of a special design, and arms loaded with respective counterweights; an interchangeable spray nozzle of different colors, and the corresponding cover assembled on the head by means of the traditional crampon-anchoring cap.

### INVENTIVE STEP

The intention of the invention is to improve the working conditions of sprinklers of this type during operation, as described for the background, such that, by simplifying construction of the apparatus and adjusting the design features and materials of the integrating parts without increasing manufacturing costs, it achieves greater efficacy in the operation thereof, and among others, prevents certain drawbacks of known mechanisms, such as the risk of unsuitable water filtering; not disposing of the debris which can be introduced inside the upper body; not facilitating the dropping down of the debris which may enter. Therefore yhe mechanism improves the way of attaching the piston to the body of the casing; the adoption of fixed adjustment means; a non-detachable assembly of the shaft of the sprinkler head; a simpler structure divided into a lower and a upper body of the sprinkler head and a simpler development of the swing arm without counterweights.

### DESCRIPTION OF THE INVENTION

In relation to the inventive step provided in the previous paragraph, a filtering element with a particular design has been provided for which is especially fixed inside of the water feed or supply inlet, such that the impurities which may be dragged remain retained in said filter, since it has a collector effect of the particles when they drop down, retaining them, leading them outside of the piston to the casing, more specifically to the bottom of the latter, such that the filter is dragged in the lifting of the piston when the pressure of the water passing through the filter makes it move upwards, but in a position favoring said retention of particles in order to prevent them from moving upwards to the spray nozzle.

Another detail of the invention, also for the same purpose, is to provide a tubular cylindrical piston having a smooth and cleared outer surface for preventing the adherence or retention of the downward moving particles, such that when it moves up or down it drags said particles or debris, which it will easily drain to the bottom of the casing or lower part of the latter in order to prevent that, when dragging said particles, they may remain retained in the mechanisms of the sprinkler head.

For the same purpose, the invention also provides for the incorporation, in the intersection or irregularity of the upper body of the casing with the lower body thereof, of spaced ports for facilitating the exit of residual water and solid debris, generally soil, which leak through or drop down when the sprinkler is operating, or are dragged when the cover closes the upper body of the casing, and which may affect the elements for rotating and changing the direction of rotation of the sprinkler.

According to the invention, the arc of these changes of rotation is controlled through a corresponding control assembly constituted of omega-shaped elements, a pair of overlapped omega-shaped elements assembled on the upper neck of the piston and made of plastic (for example, DERLIN 500) which, in the inner contour of the circular portion of said parts, have a toothing in a sawtooth form, preferably at a 114° obtuse angle, which rotate in a single direction in the neck of the piston which, for that purpose, has a grooved surface with vertical ribs spaced 60° from one another, having an approximately 30° acute angle profile which, by rotating in a single direction for controlling the rotation arc of the sprinkler head, prevent the arc from varying as a result of the thrust of said movement. It is known that the lower body of the sprinkler has a stop which butts against the branches of the omega-shaped element every time it rotates. If this stop meets no resistance, the omega-shaped element can move, varying the spray arc, taking it out of the prefixed arc which is logically the suitable arc for sprinkler operation.

Another detail of the invention is that the fixing means for fixing the lower and upper sectors of the sprinkler head use two spring rings for each sector shaft, preventing them from becoming jammed due to the soil or sand which may be housed in them.

Likewise, in another detail of the invention, the sprinkler body has a spring-fixed jet breaker screw located in a side position facing the spray nozzle for preventing the position thereof from varying due to the blade tapping against the body, and which, being a screw, can be arranged in a more or less projecting position with regard to the swing blade.

Another feature of the invention is that the shaft supporting the upper part of the body or sprinkler head, where the spring is housed which forces the return of the blade, is a metal shaft with an upper milled end which sticks to the material of the surface of said body, thus preventing said head from being released due to the effect of the rotation.

According to the invention, said sprinkler blade is a blade without counterweights, the ends of which are thickened by prismatic heads made of the same plastic material as the blade, which is specially assembled by means of welding and mechanical fixing and is provided with reinforcement ribs along the entire blade and on both sides of the latter, which perfectly withstand the stresses of the latter, even without counterweights.

A broader idea of the features of the invention will be carried out below in reference to the sheets of drawings attached to this specification which, in a somewhat schematic manner and only serving as an example, show the preferred details of the invention.

### IN THE DRAWINGS:

FIG. 1 shows a elevational view symmetrically sectioned according to a vertical plane of the underground sprinkler assembly with a pop-up sprinkler head.

FIG. 2 shows a elevational view symmetrically sectioned according to a vertical plane of the casing.

FIG. 3 shows a lower plan view of the casing of the previous figure.

FIG. 4 shows detail A of FIG. 2.

FIG. 5 shows detail B of FIG. 2.

FIG. 6 shows a elevational view symmetrically sectioned according to a vertical plane of the piston.

FIG. 7 shows the section along the A-B line of FIG. 6.

FIG. 8 shows detail C of FIG. 6.

FIG. 9 shows a partially sectioned elevational view of the piston inlet filter.

FIG. 10 shows a lower plan view of the filter of FIG. 9.

FIG. 11 shows an upper plan view of the filter of FIG. 9.

FIG. 12 shows a plan view of one of the omega-shaped control elements.

FIG. 13 shows a view along the B-B′ line of FIG. 12.

FIG. 14 shows a view of detail—A of FIG. 12.

FIG. 15 shows a plan view of the nut at a ¼ turn of assembly of the piston to the casing.

FIG. 16 shows a view partially sectioned along the A-A line of FIG. 15.

FIG. 17 shows a side elevational view of FIG. 15.

FIG. 18 shows a view of detail—B of FIG. 17.

FIG. 19 shows an elevational view of the stop spring.

FIG. 20 shows an elevational view of the milled shaft.

FIG. 21 shows a plan view by the lower plane of the sprinkler blade.

FIG. 22 shows a 90° side elevational view of FIG. 21.

FIG. 23 shows a 90° side elevational view of FIG. 21 from the opposite side.

FIG. 24 shows a 90° upper plan view of FIG. 21.

FIG. 25 shows a view of detail—F of FIG. 23.

FIG. 25A shows a view of—G cut of FIG. 25.

FIG. 26 shows a view of section—A of FIG. 23.

FIG. 27 shows a view of section—D of FIG. 23.

FIG. 28 shows a view of section—B of FIG. 23.

FIG. 29 shows a view of section—C of FIG. 23.

FIG. 30 shows an elevational view of the sprinkler body.

FIG. 31 shows a 90° side elevational view of FIG. 30.

FIG. 32 shows a 90° side elevational view of FIG. 30 from the opposite side, partially sectioned in the shank thereof.

FIG. 33 shows a 90° lower plan view of FIG. 30

FIG. 34 shows a 90° upper plan view of FIG. 30

FIG. 35 shows a view of detail—C of FIG. 30.

FIG. 36 shows a view of detail—A of FIG. 32.

### PREFERRED EMBODIMENT

According to said drawings and to that set forth in the description of the invention, a preferred embodiment of the invention is explained below, which is constituted of an underground body or casing (23) which houses all the sprinkler mechanisms and which is hermetically sealed by means of an upper cover (2) due to the effect of the permanent draw-spring (27) when pressure of the supply water, which is what drives the sprinkler assembly, stops. It is a cover (2) suitably joined to the neck (40) of the sprinkler body (4) by means of a claw cap (1).

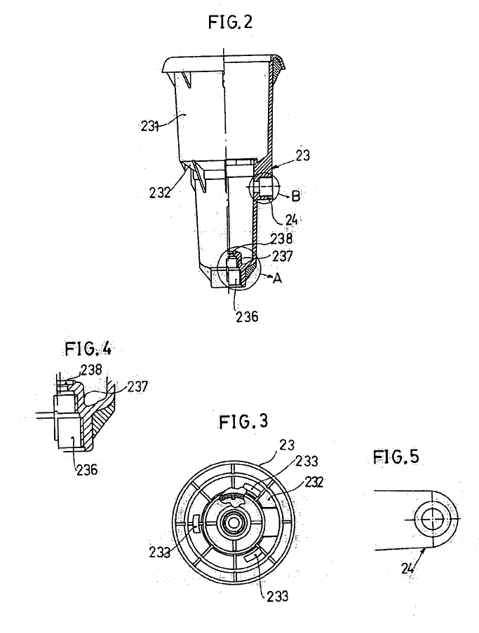

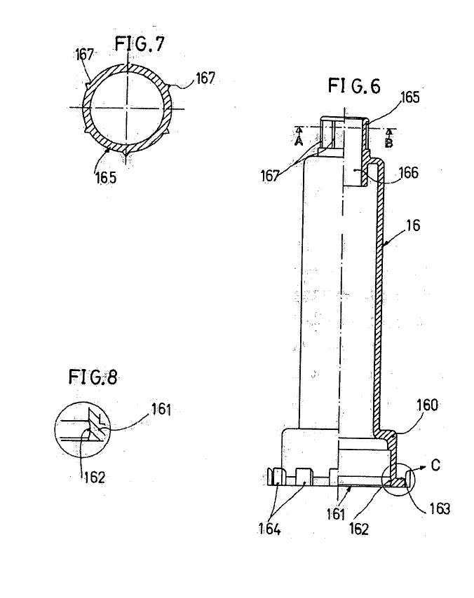

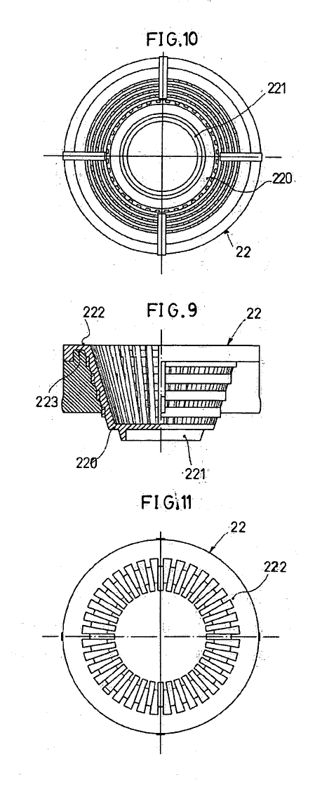

The body or casing (23) (FIGS. 2 to 5), having two parts, a lower cylindrical and tubular part (230) where the piston (16) is housed (FIGS. 6 to 8), which bears said draw-spring (27) and purifying filter (22) (FIGS. 9 to 11) for the inlet of water, and an upper part (231) where the remaining mechanisms are housed. Both parts (230 and 231) are connected by a reinforced intermediate part (232), which is a beveled part which, in areas radially equidistant at 120°, have open ports (233, 234 and 235) (FIG. 3) through which it is possible to pour outside of the sprinkler, the debris or particles dragged by the return water, mud, soil, grass or the like, when the cover (2) remains open, preventing them from remaining inside of part (231) of the body (23) and preventing them from affecting the sprinkler mechanism (4).

In said body (23), the lower part (230) is provided with a known water inlet (236) which, in this case, internally extends into a penetrating neck (237) provided with an inwardly stepped neck (238) on its inner opening provided for seating and closure of the base of the purifying filter (22). A filter (22) (FIGS. 9 to 11) having a frusto-conical (reverse according to its position) configuration with a closed minor base (220) and a concentric skirting (221) having a smaller diameter which is what fits into said neck (238), and a major base (222) with a perimetral flap (223) for being assembled in a suitable opening of the piston (16). A filter (22) which, when there is no passing of water, closes the inlet (236) such that solid particles of a certain size remain on the inside thereof and the debris of a lesser volume drop down to the bottom of the casing (23), outside of the piston (16), such that they cannot return to the inside of the sprinkler (4).

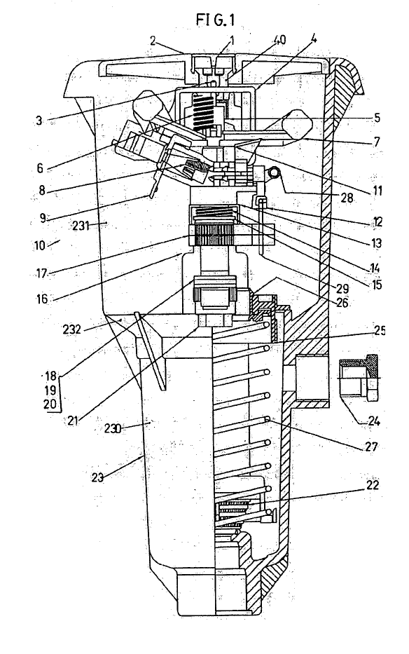

Said piston (16), which is a tubular and externally smooth cylindrical body (FIGS. 6 to 8), has on the lower end a diametral widening (160), with the internal diameter necessary for receiving the major base (222) of the filter (22), and the opening (161) of said widening portion (160) is provided with an inner concave curve seating (162) for the tight fit of said filter (22), and also has another outer projecting (163), crenellated (164) rim, as a seating of the permanent draw-spring (27). And said piston (16), on the upper end, is provided with a neck (165) having a smaller diameter, with an outer part provided with vertical grooves or ribs (168), with acute triangle profile, provided for the purpose of engaging with the omega-shaped flanges (17) (FIGS. 12 to 14) intended for fixing the spray arc of the sprinkler (4), and another inner part (166) of said neck adapted for receiving a closure plug (21) holding the feed conduit of the sprinkler (4) (FIG. 1) equipped with a sealed gasket constituted of two rubber washers (18 and 20) and another intermediate Teflon washer (19).

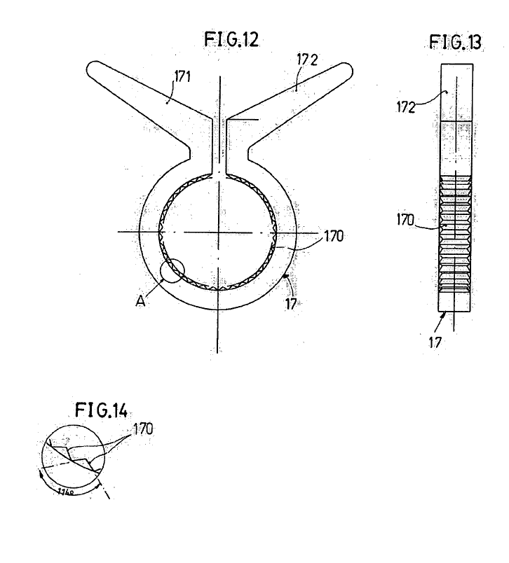

At the height of the piston (16) coinciding with the plane of intersection (232) of the body (23), the latter is fixed by means of a quarter turned cover-nut (25) (FIGS. 15 to 18) with the interposition of a leak-tight joint (26) stored in a respective housing (259) through the opening of said nut (25) which has a circular outer plane (250) with a superficial relief (251) with bevels (252 and 253) on two sides for applying a special tool for opening and closing said cover-nut (25) which, in its contour, is provided with projecting teeth (254) equidistant at 120°, of arcuate wedge profile for ensuring the increasing pressure of the closure of said cover-nut (25), and the teeth (254) of which have a slight superficial step (256) for the embedding of said teeth (254) in a respective rib of the intersection (232) of the body (23), not seen in FIG. 1, and which justifies said closure of the cover-nut (25) at a quarter turn.

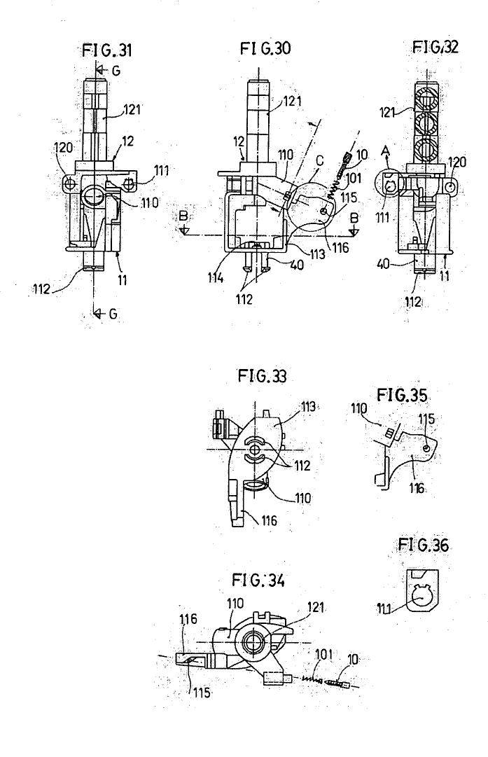

Said omega-shaped flanges (17) assembled on the neck (165) of the piston (16) (FIGS. 6 to 8) are provided with an annular body projecting in two divergent branches (171) and (172) for providing it with said omega shape and which, on the inside of the annular body (17), have a toothing (170) with a continuous succession of teeth at 114°, specially designed for engaging in the grooves (167) of the neck (165) which, due to the 60° spacing of the grooves (165) and the acute triangle profile of the latter, permits rotation of the omega-shaped flanges (17) in a single direction or only clockwise, for arranging the spray arc adjusting device of the sprinkler (4) which, for that purpose, is constituted of a set of two overlapping omega-shaped flanges (17) and (173) (FIG. 1) and which branches (171) and (172) constitute the references for limiting the rotation of the lower body (12) of the sprinkler which, in this case, has a stop formed by a spring-square (29) (FIG. 19) which is a stainless steel wire part in the shape of an elongated trapeze, having an opening (290) at the major base, producing two anchors (291) and (292) which are coupled in the lower sector (12) of the sprinkler head (FIGS. 30 to 36), more specifically in a side housing (120) of said lower sector (12) which, together with the upper sector (11), integrate the sprinkler body (4) which, in this case, is provided with an adjustable jet breaker screw (10) housed, with the interposition of a damping spring (101), in a biased housing (115) contained on a side extension (116) of the head (113) of said upper sector (11) (FIGS. 30 and 34), and is oriented laterally to the spray conduit (110) provided with its corresponding nozzle (9) and filter (8), such that the screw (10) breaks the spray jet as it crosses with it, since it can project more or less, making the jet to be spread more or less according to the impact.

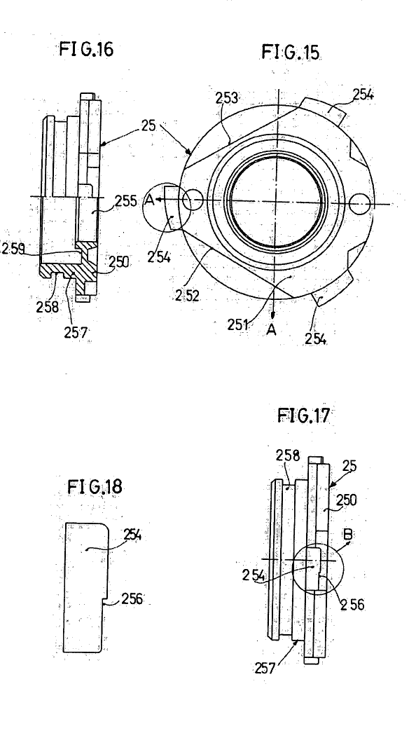

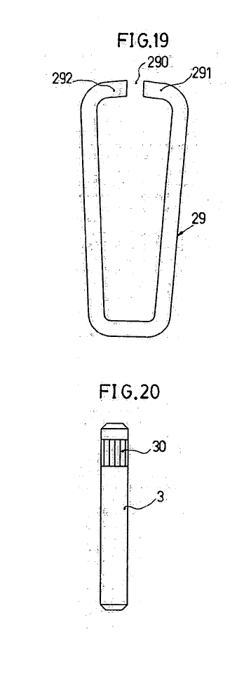

The lower sector (12) is also integrated by the feed conduit (121) of the spray conduit through which the spray conduit (110) (FIGS. 30 to 32) is fed and from which the shaft (3) for holding the lower (12) and upper (11) sector of the sprinkler body (4) projects; a stainless steel shaft (3) having a milled end (30) (FIG. 20) rigidly fixed to the head (113) of the upper sector (11) in a corresponding enclosure (114) for preventing the spray body (4) from becoming loose due to the effect of the regular movement of the sprinkler when in spraying operation. The enclosure (114) is located in the center of the neck (40) between the claws (112) acting as an anchor to the cap (1) which holds the cover (2) closing the body (231) of the casing (23).

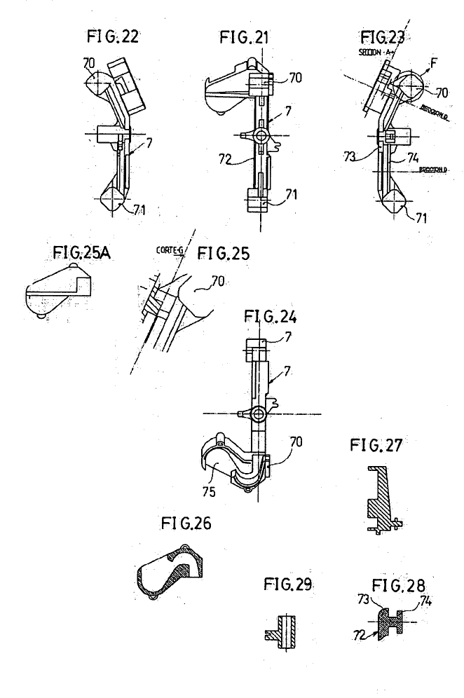

The swing diffuser blade (7) is assembled on the stainless steel shaft (3) itself, on the upper sector (11) of the sprinkler body (4), which blade is pressed on by the corresponding torsion spring (6) of the sprinkler body (4), with the inclusion of a respective plate (5) of the stainless steel shaft (3). According to the invention, a diffuser swing blade (7) (FIGS. 21 to 24) constituted of a single plastic (DERLIN 500) part having respective irregular prismatic rolls (70-71) acting as counterweights without having any dead weight whatsoever and located on the ends of an arm (72) in the shape of a wide open yoke, which is an arm reinforced by longitudinal ribs (73) and (74) (FIG. 28) giving the diffuser swing blade (7) a strong consistency, which blade, on one end, has the corresponding diffuser sprayer (75) having a known “S” shape. Finally, the swing device of said blade (7) is completed with spring (28) (FIG. 1) of the catch which fixes or releases the swinging of said blade (7), and, in an axial position, under the lower sector (12), an anti-sand plate (13), the compensating damping spring (14) and the spring washer (15) (FIG. 1) are arranged. It is also provided with the corresponding side safety plug (25) (FIG. 1).

Having suitably described the nature of the invention, it is stated for the record that the invention is not limited to the exact details of this description, but rather on the contrary, those modifications deemed suitable will be introduced, as long as they do not alter the essential features thereof, which are claimed below.

1. An underground sprinkler with a pop-up head, consisting of a corresponding underground casing, it has two differentiated cylindrical parts, closed by a corresponding cover fixed to the pop-up sprinkler head, which, being a part coupled to the piston, pops-up due to the effect of the water pressure pushing said piston in a portion calculated for said purpose and which is so maintained for as long as said pressure lasts, to be recovered by the action of a permanent draw-spring when the pressure stops, and having respective filtering means, piston guiding and holding means, spray arc and sprinkler head swing control means and means for assembling the sprinkler head, characterized in that it comprises: in the intersection (232) of the two bodies (230-231) of the casing (23), draining and cleaning means for preventing the jamming of the sprinkler mechanisms (4); a special cover-nut (25) adjusting at a quarter turn against said intersection (232) which is assembled and disassembled with a special tool and which serves as assembly to the piston (16), which is a specially smooth, tubular cylindrical body which, on the lower end, has fitting means for fitting a respective inlet filter (22); a closure and anti particle or impurity return filter (22); an upper end with control means for controlling respective. Reference omega-shaped elements (17-173) for the spray arc; a stop (29) for the catch of the lower body (12) of the sprinkler (4); a non-detachable stainless steel shaft (3) for assembly of the lower (12) and upper (11) body of the sprinkler (4); a jet breaker element (10); a single-piece, plastic, reinforced diffuser blade (7) without counterweights.

2. An underground sprinkler with a pop-up head according to claim 1, the draining and cleaning means are characterized in that they are openings (233, 234 and 235) provided on the beveled surface of the intersection (232) of both bodies (230, 231) of the casing (23), preferably arranged at 120°.

3. An underground sprinkler with a pop-up head according to claim 1, the special cover-nut quarter turn fit is characterized in that it is a part (25) having a cylindrical body (250) of circular plan provided with a superficial rib (251) with bevels (252, 253) on two sides for the application of a special tool for opening and closing, and provided with projecting arcuate wedge-shaped teeth (254) on the perimetral edge and with a slight stepping (256) with the bases for said quarter turn embedding in at least three points at 120°, and it is provided with a central passage (255) for the piston (16), and a circumscribed circular housing (259) on the inside for storing a joint (26) having a profile suitable for fitting to said piston (16), and another doughnut-shaped housing (258) for a joint for fitting to the corresponding body (230).

4. An underground sprinkler with a pop-up head according to claim 1, the piston is characterized in that it comprises an externally smooth, tubular cylindrical body (16) which, on the lower end, has a widened and internally conditioned part (160) with a concave curve seating (162) for adapting the major base (222) of the purifying filter (22) and, on the upper end, it has a smaller diameter neck (165) provided with several external vertical grooves or ribs (167) for the corresponding adaptation of the omega-shaped elements (17-173) controlling the spray arc.

5. An underground sprinkler with a pop-up head according to claim 4, the vertical grooves or ribs are characterized in that they are grooves or ribs (167) with an acute triangle profile and they are equidistantly distributed, preferably at a 60° spacing.

6. An underground sprinkler with a pop-up head according to claim 4, the purifying filter for the water inlet is characterized in that it comprises a frusto-conical body (22) inverted according to its assembly position, having a closed minor base (220) and another upper, open major base (222) with a perimetral flap (223) for pressure fitting in the lower conditioned part (162) of the piston (16).

7. An underground sprinkler with a pop-up head according to claim 6, the minor base of the filter is characterized in that it has a concentric outer rim (221) which is housed and closed in an inner stepped (238) neck (237) of the inlet (236) or intake of the lower body (230) of the casing (23).

8. An underground sprinkler with a pop-up head according to claim 5, the omega-shaped elements controlling the spray arc are characterized in that they comprise an annular body (17) projected in two divergent branches (171-172) justifying said omega shape, and which internally, on the annular body (17), have a triangular toothing (170) preferably at 114°, which rotate in a single direction or only clockwise in said grooves or ribs (167) of the upper neck (165) of the piston (16).

9. An underground sprinkler with a pop-up head according to claim 8, the stop for said omega-shaped elements is characterized in that it comprises a stainless steel wire part (29) in the form of an elongated trapezium having a central opening (290) on the major base, producing two anchors (291-292) which are fixed in a corresponding housing (120) of the lower sector (12) of the sprinkler (4).

10. An underground sprinkler with a pop-up head according to claim 1, the stainless steel shaft for assembling the sprinkler body is characterized in that the upper end of said shaft (3), according to its assembly, comprises a milled space (30) where the head (113) of the sprinkler (4) is non-detachably fixed.

11. An underground sprinkler with a pop-up head according to claim 1, the jet breaker is characterized in that it comprises a controlling screw (10) incorporating a damping spring (101) and which screws into a biased hole (115) provided on a side extension (116) of the upper sector (11) of the sprinkler (4), directly facing the outlet (110) of the spray nozzle (9).

12. An underground sprinkler with a pop-up head according to claim 1, the jet diffusing blade, provided in a single, plastic part, is characterized in that it comprises a wide open fork-shaped arm (7) with irregular prismatic rolls on its ends (70-71), without counterweights, and with longitudinal reinforcement ribs (73-74) on both sides of the arm (7).
